(19) United States
(12) Patent Application Publication
(10) Pub. No.: US 2012/0085976 A1
(43) Pub. Date: Apr. 12, 2012

(54) Sintering composition and sintering method

(75) Inventors: Chang-Shu Kuo, Tainan City (TW); In-Gann Chen, Tainan City (TW)

(73) Assignee: National Cheng Kung University, Tainan City (TW)

(21) Appl. No.: 13/064,170

(22) Filed: Mar. 9, 2011

(30) Foreign Application Priority Data
Oct. 6, 2010 (TW) 099133998

(51) Int. Cl. H01B 1/02; H01B 1/00; B82Y 30/00

(52) U.S. Cl. 252/512; 252/500; 977/773

(57) ABSTRACT

The present invention relates to a sintering composition and a sintering method. The sintering composition includes: a plurality of sintering raw materials; and an energetic reagent of which decomposition temperature ranges from 50° C. to 400° C. Accordingly, the present invention can reduce the sintering temperature by adding the energetic reagent in an appropriate amount.

### CROSS REFERENCE TO RELATED APPLICATION

This application claims the benefits of the Taiwan Patent Application Serial Number 099133998, filed on Oct. 6, 2010, the subject matter of which is incorporated herein by reference.

### BACKGROUND OF THE INVENTION

1. Field of the Invention

The present invention relates to a sintering composition and a sintering method and, more particularly, to a sintering composition and a sintering method that can allow more energy to be confined in a selected area.

2. Description of Related Art

In conventional art, a printed circuit board (PCB) for supporting active/passive electronic or photoelectric components is manufactured by printing a conductive material (such as copper paste, silver paste or other metal pastes) on an insulating substrate to form circuit patterns. However, the conventional printing process shows low line resolution and thus cannot meet the requirements for high packaging density. Accordingly, the photolithography technology with higher line resolution has been developed to replace the printing technology. In general, the photolithography method includes steps of photoresist coating, mask alignment, exposure, developing and photoresist removal, and thereby has the disadvantages of time consumption and high cost. Particularly, in miniaturization of patterns on the substrate using the photolithography technology, more expensive exposure systems are required, and the pitch size and line width are much more difficult to be precisely controlled.

In order to manufacture printed circuit boards with finer line width and to meet the requirement for simplifying the process, an inkjet printing method was proposed and demonstrated for the reduction of process steps and the high flexibility of circuit patternings. Additionally, in comparison with the photolithography technology that cannot be favorably applied in the recently-developed flexible electronics (such as RFID, flexible e-books, flexible displays, flexible solar cells etc.), the inkjet printing method has the advantages as a novel manufacturing process suitable for flexible electronic devices using polymer-based substrates.

However, in order to prevent the polymer substrate deformation during the sintering process of metal circuits, the heat deflection temperature of the substrate should be carefully considered, and consequently the choice of the substrate is limited. Thereby, the inkjet printing method still cannot be widely applied to polymer substrates having low heat deflection temperature, such as PET substrates.

### SUMMARY OF THE INVENTION

The object of the present invention is to provide a sintering composition, which can provide additional joule heat and allow it mostly to be confined in selected and localized areas. Accordingly, the sintering composition of the present invention is advantageous to well-defined sintering of raw materials. In addition, the thermal treatment of the sintering composition in the present invention can be conducted at a lower temperature or be completed in shorter period of time, such that the possible damages of the substrate or other components caused by the high temperature treatment can be inhibited.

To achieve the object, the present invention provides a sintering composition, including: a plurality of sintering raw materials; and an energetic reagent of which decomposition temperature ranges from 50° C. to 400° C. Herein, the present invention uses an energetic reagent as an additional heat source to accelerate the heat accumulation required for the sintering process. Accordingly, the sintering composition of the present invention is advantageous to well-defined sintering of raw materials. Moreover, the processing temperature can be modified by controlling the amount of the energetic reagent in the sintering composition. Particularly, a sintering process can be favorably applied to a polymer substrate having low heat deflection temperature by using the sintering composition according to the present invention, and applications of the sintering process to flexible electronics can be achieved.

In addition, the present invention further provides a sintering method, including the following steps: providing a sintering composition, which includes a plurality of sintering raw materials and an energetic reagent of which decomposition temperature ranges from 50° C. to 400. ° C.; and performing a thermal treatment at a temperature higher than the decomposition temperature to sinter the sintering raw materials into a sintered product.

In the present invention, the energetic reagent is not particularly limited and may be any chemical substance capable of releasing heat by its thermal decomposition. Preferably, the energetic reagent is a chemical substance capable of releasing heat by its thermal decomposition at a temperature from 50° C. to 400° C., such as peroxides, nitrates, perchlorates, nitrobenzene-based compounds or a mixture thereof. Herein, the examples of peroxides include, but are not limited to, benzoyl peroxide (its decomposition temperature being about 80° C.), cumene hydroperoxide (its decomposition temperature being about 130° C.), di-tert-butyl peroxide (its decomposition temperature being about 120° C.), methyl-ethyl-ketone peroxide (its decomposition temperature being about 150° C.), tert-butyl hydroperoxide (its decomposition temperature being about 200° C.), lauroyl peroxide (its decomposition temperature being about 70° C.), tertbutyl peroxybenzoate (its decomposition temperature being about 100° C.), dicumyl peroxide (its decomposition temperature being about 110° C.). The examples of nitrates include, but are not limited to, ammonium nitrate (its decomposition temperature being about 200° C.), potassium nitrate (its decomposition temperature being about 400° C.), urea nitrate (its decomposition temperature being about 180° C.). The examples of perchlorates include, but are not limited to, ammonium perchlorate (its decomposition temperature being about 350° C.). The examples of nitrobenzene-based compounds include, but are not limited to, picric acid (its decomposition temperature being about 250° C.), dinitrotoluene (its decomposition temperature being about 350° C.).

In the present invention, the sintering composition may further include: a solvent, a dispersant, a surfactant or a mixture thereof.

In the present invention, the sintering raw materials may be metal nanomaterials, and the sintering composition may be a conductive ink. According to one aspect of the present invention, the sintering composition may be a conductive ink including: metal nanomaterials, an energetic reagent, a solvent and a surfactant. Based on the weight of the solvent, the total amount of the metal nanomaterials and the energetic reagent may range from 0.5 to 80 wt %, more preferably from 5 to 60 wt %, and most preferably from 16 to 40 wt %.

In the present invention, the solvent, dispersant and surfactant are not particularly limited and may be any conventional suitable solvent, dispersant and surfactant. Herein, the solvent may be a hydrophilic solvent or a hydrophobic solvent, and the surfactant may be a hydrophilic surfactant or a hydrophobic surfactant. One aspect of the present invention provides a sintering composition, including: a plurality of sintering raw materials, an energetic reagent, a hydrophobic solvent and a hydrophobic surfactant. Additionally, another aspect of the present invention provides another sintering composition, including: a plurality of sintering raw materials, an energetic reagent, a hydrophilic solvent and a hydrophilic surfactant. For example, conventional surfactants include thiol-based surfactants, silane-based surfactants, polymer-based surfactants, amine-based surfactants, carboxylic acid-based surfactants. The examples of conventional hydrophobic surfactants include, but are not limited to, alkylthiol-based surfactants, alkylsilane-based surfactants, alkylamine-based surfactants, alkyl carboxylic acid-based surfactants. The examples of conventional hydrophilic surfactants include, but are not limited to, hydroxyl thiol-based surfactants (such as HO—C₂H₄—SH), carboxyl thiol-based surfactants (HOOC—C₂H₄—SH), tricarboxyl acid-based surfactants (such as citric acid).

In the present invention, the metal nanomaterials may be any types of metal nanomaterials, including metal nanoparticles, metal nanowires/rods, metal nanofibers, metal nano thin film and so on.

In the present invention, the weight ratio of the sintering raw materials to the energetic reagent preferably ranges from 1/1 to 300/1, more preferably from 2/1 to 128/1, and most preferably from 8/1 to 32/1.

In the present invention, preferably, the thermal treatment is performed at a temperature lower than 500° C. More specifically, in the case of using benzoyl peroxide (its decomposition temperature being about 80° C.) as the energetic reagent, the thermal treatment preferably is performed at a temperature from 120° C. to 400° C., more preferably from 120° C. to 300° C., and most preferably from 120° C. to 240° C. If ammonium nitrate (its decomposition temperature being about 200° C.) is used as the energetic reagent, the thermal treatment preferably is performed at a temperature from 120° C. to 400° C.

In the present invention, the sintering composition may be provided on a substrate, and the sintered product may be a conductive film, a conductive pattern or a conductive joint. Herein, the method for providing the sintering composition on a substrate is not particularly limited and may be spin coating, cast coating, dip coating or inkjet printing. In addition, the substrate is not particularly limited and may be any conventional suitable substrate. Preferably, the substrate is a polymer substrate, such as a polyimide substrate or a PET substrate.

As above mentioned, the present invention uses an energetic reagent as an additional heat source, which can encourage more heat to be confined in the selected and localized area through the exothermal decomposition of the energetic reagent. Accordingly, the sintering composition of the present invention is advantageous to well-defined sintering of raw materials, and the processing temperature can be modified by controlling the amount of the energetic reagent in the sintering composition. Thereby, the possible damages of the substrate or other components caused by the high temperature treatment can be inhibited, and a sintering process can be favorably applied to a polymer substrate having low heat deflection temperature by using the sintering composition according to the present invention.

### BRIEF DESCRIPTION OF THE DRAWINGS

FIG. 1 shows a diagram of BPO/Au nanoparticles weight ratio vs. the temperature that initiates the sintering of the gold nanoparticles according to Examples 1-7;

FIG. 2 shows a diagram of sintering temperature vs. resistivity of the gold thin film according to Examples 1-5 and Comparative Example 2; and

FIG. 3 shows a diagram of sintering temperature vs. sheet resistance of the gold thin film according to Examples 6-8.

### DETAILED DESCRIPTION OF THE PREFERRED EMBODIMENT

Hereafter, examples will be provided to illustrate the embodiments of the present invention. Other advantages and effects of the invention will become more evident from the disclosure of the present invention. Other various aspects also may be practiced or applied in the invention, and various modifications and variations can be made without departing from the spirit of the invention based on various concepts and applications.

### Example 1

Surfactant stabilized metal nanoparticles (about 200 mg) were dispersed in toluene (about 1 mL). In the present example, gold nanoparticles stabilized by C₈H₁₇SH (i.e. Au:HS—C₈H₁₇) were used, and the gold nanoparticles were synthesized by two-phase Brust-Schiffrin method. In the two-phase Brust-Schiffrin method, tetraoctyl ammoniumbromide was used as a phase transfer reagent, and complex intermediates were formed by gold cations and n-alkanethiol before the reduction of gold cations, resulting in stabilization of nanoparticles. Subsequently, the surfactant stabilized gold nanoparticles were purified by using an alcohol solvent and then dried so as to obtain nanoparticles of Au:HS—C₈H₁₇. The diameter (about 3-4 nm) of the obtained gold nanoparticles was determined by transmission electron microscopy (TEM). In addition, thermogravimetric analysis (TGA) was applied to measure the weight loss of gold nanoparticles by heating the gold nanoparticles under nitrogen atmosphere and a heating rate of 10° C./min. The results showed that the gold nanoparticles contained surfactants in an amount of about 21.5 wt % and gold element in an amount of about 78.5 wt %.

Subsequently, benzoyl peroxide (BPO, about 1.23 mg) was added into the toluene solution of Au:HS—C₈H₁₇ (the weight ratio of gold element to BPO being about 128), so as to obtain a hydrophobic conductive ink A.

### Example 2

The method for preparing the conductive ink of the present example was the same as that illustrated in Example 1, except that benzoyl peroxide of about 2.45 mg was added into the toluene solution of Au:HS—C₈H₁₇ (the weight ratio of gold element to BPO being about 64), thus obtaining a hydrophobic conductive ink B.

### Example 3

The method for preparing the conductive ink of the present example was the same as that illustrated in Example 1, except that benzoyl peroxide of about 4.91 mg was added into the toluene solution of Au:HS—C₈H₁₇ (the weight ratio of gold element to BPO being about 32), thus obtaining a hydrophobic conductive ink C.

### Example 4

The method for preparing the conductive ink of the present example was the same as that illustrated in Example 1, except that benzoyl peroxide of about 9.81 mg was added into the toluene solution of Au:HS—C₈H₁₇ (the weight ratio of gold element to BPO being about 16), thus obtaining a hydrophobic conductive ink D.

### Example 5

The method for preparing the conductive ink of the present example was the same as that illustrated in Example 1, except that benzoyl peroxide of about 19.63 mg was added into the toluene solution of Au:HS—C₈H₁₇ (the weight ratio of gold element to BPO being about 8), thus obtaining a hydrophobic conductive ink E.

### Example 6

The method for preparing the conductive ink of the present example was the same as that illustrated in Example 1, except that benzoyl peroxide of about 39.25 mg was added into the toluene solution of Au:HS—C₈H₁₇ (the weight ratio of gold element to BPO being about 4), thus obtaining a hydrophobic conductive ink F.

### Example 7

The method for preparing the conductive ink of the present example was the same as that illustrated in Example-1, except that benzoyl peroxide of about 78.5 mg was added into the toluene solution of Au:HS—C₈H₁₇ (the weight ratio of gold element to BPO being about 2), thus obtaining a hydrophobic conductive ink G.

### Example 8

The method for preparing the conductive ink of the present example was the same as that illustrated in Example 1, except that benzoyl peroxide of about 157 mg was added into the toluene solution of Au:HS—C₈H₁₇ (the weight ratio of gold element to BPO being about 1), thus obtaining a hydrophobic conductive ink H.

### Example 9

Surfactant stabilized metal nanoparticles (about 200 mg) were dispersed in ethanol/water (1:1, about 1 mL). In the present example, silver nanoparticles stabilized by HOC₂H₄SH (i.e. Ag:HS—C₂H₄OH) were used. Subsequently, ammonium nitrate was added into the ethanol/water solution of Ag:HS—C₂H₄OH to obtain a hydrophilic conductive ink I, therewith the weight ratio of silver element to ammonium nitrate being about 128.

### Examples 10-16

The methods for preparing the conductive inks of Examples 10-16 were the same as that illustrated in Example 9, except that the weight ratios of silver element to ammonium nitrate according to Examples 10-16 were shown in Table 1.

TABLE 1

| | | Weight Ratio of Silver to Ammonium |
|---|---|---|
| | Conductive Ink | Nitrate |
| Example 10 | J | 64 |
| Example 11 | K | 32 |
| Example 12 | L | 16 |
| Example 13 | M | 8 |
| Example 14 | N | 4 |
| Example 15 | O | 2 |
| Example 16 | P | 1 |

### Comparative Example 1

The method for preparing the conductive ink of this comparative example was the same as that illustrated in Example 1, except that no benzoyl peroxide was added, and the amount of Au:HS—C₈H₁₇ in the toluene solution was 20 wt %.

### Comparative Example 2

The method for preparing the conductive ink of this comparative example was the same as that illustrated in Example 1, except that no benzoyl peroxide was added, and the amount of Au:HS—C₈H₁₇ in the toluene solution was 30 wt %.

### Test Example 1

The conductive inks prepared by Examples 1-7 and Comparative Example 1 were uniformly coated on a polyimide (Kapton) substrate for 15 seconds via a spin coater under 4000 rpm. After the evaporation of solvent, a uniform thin film of gold nanoparticles was formed on the substrate. Subsequently, localized thermal analysis was performed through a Wollaston thermal probe equipped with a micro-thermal analyzer (manufactured by Anasys Instrument Co., Nano-TA™) to observe microscopic thermal properties of gold nanoparticles. In the present test example, the localized thermal analysis was performed fifteen times on each sample, and ten curves with better reproducibility were taken from the fifteen tests. Accordingly, the required sintering temperatures of gold nanoparticles can be determined from the center of full width at half maximum of the peak obtained from the first-order derivative of thermal signal with respect to temperature.

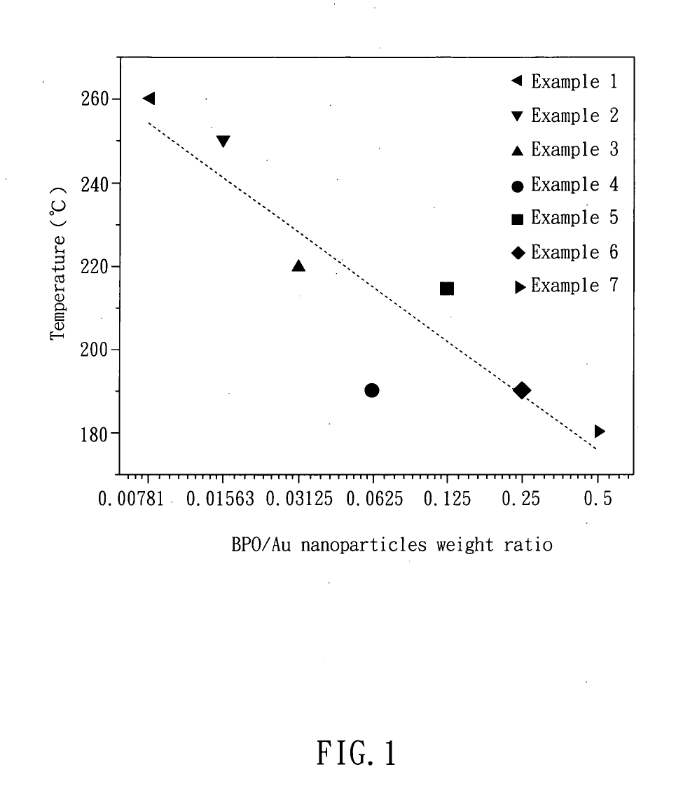

According to the results, it can be found that the required sintering temperature of gold nanoparticles according to Comparative Example 1 was about 270° C., and the required sintering temperature of gold nanoparticles can be reduced by increasing the amount of benzoyl peroxide (BPO) and thus increasing additional heat, based on the data shown in FIG. 1 (Examples 1-7). In details, the measured sintering temperatures were 260° C. for Example 1 (weight ratio of BPO/Au=128), 250° C. for Example 2 (weight ratio of BPO/Au=64), 220° C. for Example 3 (weight ratio of BPO/Au=32), 190° C. for Example 4 (weight ratio of BPO/Au=16), 190° C. for Example 6 (weight ratio of BPO/Au=4), and 180° C. for Example 7 (weight ratio of BPO/Au=2).

Thereby, it can be confirmed that the addition of BPO can efficiently reduce the required sintering temperature, and the sintering composition according to the present invention is suitable for a low temperature process.

### Test Example 2

The conductive inks prepared by Examples 1-8 and Comparative Example 2 were uniformly coated on a polyimide (Kapton) substrate for 15 seconds via a spin coater under 4000 rpm. After the evaporation of solvent, a uniform thin film of gold nanoparticles was formed on the substrate. Subsequently, isothermal treatment was performed at different temperatures in a furnace (Nabertherm Gmbh L 3/11 1100) for 30 minutes, and then a four-probe setup (Keithley 2400, Napson. RT-7) was used to measure resistivity or sheet resistance so as to evaluate their conductivity.

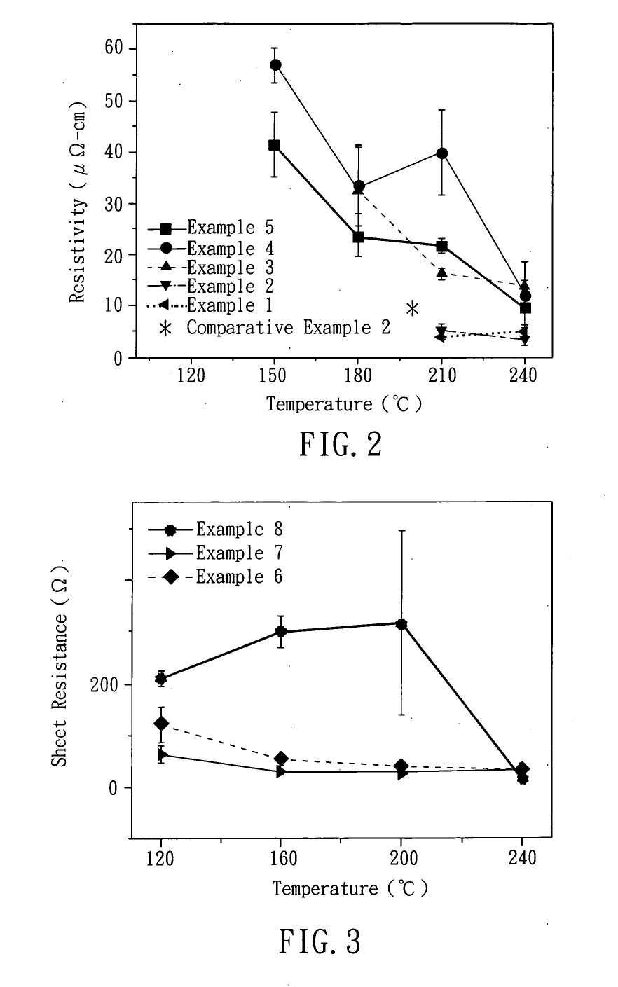

FIGS. 2 and 3 show a resistivity vs. temperature diagram and a sheet resistance vs. temperature diagram with respect to samples having different weight ratios of Au/BPO. Herein, the resistivity of the spin-coated thin film of gold nanoparticle suspension according to Comparative 2 was measured after the isothermal treatment at 200° C. for 30 minutes under a reducing atmosphere of 10 wt % hydrogen and 90 wt % nitrogen, and the result is shown at the * position in FIG. 2. In addition, the resistivity or sheet resistance of each thin film including gold nanoparticles and BPO was measured after the isothermal treatment under air atmosphere.

As shown in FIG. 2, in the isothermal treatment, the sintering degree of gold nanoparticles can be enhanced by raising the temperature, resulting in the reduction of resistivity. In addition, the effect of BPO amount on conductivity at the same temperature was discussed. Based on the curves of Example 3 (weight ratio of BPO/Au=32), Example 4 (weight ratio of BPO/Au=16) and Example 5 (weight ratio of BPO/Au=8) at the same temperature of 240° C., it can be confirmed that the conductivity of the gold thin film can be enhanced by increasing BPO, owing to that the increase of BPO amount would cause more heat generated by exothermal decomposition of BPO and thus enhance the sintering degree of gold nanoparticles, resulting in the reduction of sheet resistance or resistivity. With respect to Example 2 (weight ratio of BPO/Au=64) and Example 1 (weight ratio of BPO/Au=128), although the conductivity of the gold thin film was initiated at 210° C., the resistivity (5.2 μΩ-cm, 3.9 μΩ-cm) was much lower than the compared data of 9.4 μΩ-cm and nearly equal to 2.2 μΩ-cm of gold bulk. Thereby, it can be recognized that the extra joule heat would encourage the sintering of gold nanoparticles to thereby obtain a gold thin film with enhanced conductivity. Moreover, regarding the effect of BPO amount on the minimum temperature required for conductivity, as shown FIGS. 2 and 3, it can be found that the increase of BPO amount with respect to Au nanoparticles would reduce the required temperature. For example, in comparison with the minimum temperature of 210° C. required for conductivity according to Example 1 (weight ratio of BPO/Au=128) and Example 2 (weight ratio of BPO/Au=64), the minimum temperatures required for conductivity were lowered to 180° C. according to Example 3 (weight ratio of BPO/Au=32), 150° C. according to Example 4 (weight ratio of BPO/Au=16) and Example 5 (weight ratio of BPO/Au=8), and 120° C. according to Example 6 (weight ratio of BPO/Au=4), Example 7 (weight ratio of BPO/Au=2) and Example 8 (weight ratio of BPO/Au=1), respectively. However, FIG. 3 shows that the sheet resistances according to Examples 6, 7 and 8 were higher than those of other samples having less BPO, due to that the residual BPO and larger mass of CO₂ generated from the decomposition of BPO would cause the increase of holes in the gold thin film, resulting in the deterioration of conductivity and increase of sheet resistance.

As above mentioned, the present invention uses an energetic reagent as an additional heat source, which can encourage more heat to be confined in the selected and localized area through the exothermal decomposition of the energetic reagent. Accordingly, the sintering composition of the present invention is advantageous to well-defined sintering of raw materials, and the processing temperature can be modified by controlling the amount of the energetic reagent in the sintering composition. Thereby, the problem of damages on the substrate or other components caused by high temperature in the manufacturing process can be inhibited, and a sintering process can be favorably applied to a polymer substrate having low heat deflection temperature by using the sintering composition according to the present invention.

The above examples are intended for illustrating the embodiments of the subject invention and the technical features thereof, but not for restricting the scope of protection of the subject invention. The scope of the subject invention is based on the claims as appended.

What is claimed is:

1. A sintering composition, comprising:
a plurality of sintering raw materials; and
an energetic reagent of which decomposition temperature ranges from 50° C. to 400° C.

2. The sintering composition as claimed in claim 1, further comprising: a solvent, a dispersant, a surfactant or a mixture thereof.

3. The sintering composition as claimed in claim 1, wherein the sintering raw materials are metal nanomaterials.

4. The sintering composition as claimed in claim 2, wherein the sintering raw materials are metal nanomaterials, and the sintering composition is a conductive ink.

5. The sintering composition as claimed in claim 1, wherein the energetic reagent is a peroxide, a nitrate, a perchlorate, a nitrobenzene-based compound or a mixture thereof.

6. The sintering composition as claimed in claim 1, wherein the weight ratio of the sintering raw materials to the energetic reagent ranges from 1/1 to 300/1.

7. A sintering method, comprising:
providing a sintering composition, which comprises a plurality of sintering raw materials and an energetic reagent of which decomposition temperature ranges from 50° C. to 400° C.; and
performing a thermal treatment at a temperature higher than the decomposition temperature to sinter the sintering raw materials into a sintered product.

8. The sintering method as claimed in claim 7, wherein the sintering composition further comprises: a solvent, a dispersant, a surfactant or a mixture thereof.

9. The sintering method as claimed in claim 7, wherein the energetic reagent is a peroxide, a nitrate, a perchlorate, a nitrobenzene-based compound or a mixture thereof.

10. The sintering method as claimed in claim 7, wherein the weight ratio of the sintering raw materials to the energetic reagent ranges from 1/1 to 300/1.

11. The sintering method as claimed in claim 7, wherein the thermal treatment is performed at a temperature lower than 500° C.

12. The sintering method as claimed in claim 8, wherein the sintering raw materials are metal nanomaterials, the sintering composition is a conductive ink, and the sintered product is a conductive film, a conductive pattern or a conductive joint.

13. The sintering method as claimed in claim 12, wherein the sintering composition is provided to a substrate.
